(19) United States
(12) Patent Application Publication
(10) Pub. No.: US 2026/0370032 A1
(43) Pub. Date: Nov. 19, 2026

(54) ELECTRIC POWER ASSISTED PHASE LOSS RECOVERY FOR COMBUSTION SYSTEMS

(71) Applicant: General Electric Company, Evendale, OH (US)

(72) Inventors: Stefan Joseph Cafaro, Chapel Hill, NC (US); Justin Edwin Barton, North Huntingdon, PA (US); Kalpesh Singal, Mechanicville, NY (US); Mahnoor Ajaz, Lafayette, IN (US)

(21) Appl. No.: 19/206,340

(22) Filed: May 13, 2025

(51) Int. Cl. H02J 9/06; B64D 41/00; F01D 21/00; F01D 21/14

(52) U.S. Cl. CPC H02J 9/06; B64D 41/00; F01D 21/003; F01D 21/14

(57) ABSTRACT

In some embodiments, apparatuses and methods are provided herein useful to utilize electric power to recover phase loss in an engine. In some embodiments, a gas turbine engine includes a fuel system providing fuel to a combustor coupled to an engine shaft; an electric machine configured to supply torque to the engine shaft; and a main controller coupled to the electric machine and the fuel system. The main controller detects a combustor phase loss condition based on a sensed change of a target engine parameter; increases a power supplied by the electric machine in response to detection of the combustor phase loss condition while simultaneously controlling the fuel system according to the sensed change of the target engine parameter; and/or in response to a measured target engine parameter meeting a desired target engine parameter, reduces the power supplied by the electric machine to a base power.

### TECHNICAL FIELD

This disclosure relates generally to turbine engines and more particularly to controlling the operation of components associated with turbine engines.

### BACKGROUND

Various aircraft engine components are controlled by different types of commands. Commands may originate from a pilot (e.g., moving a lever or switch in the cockpit of an aircraft) or may originate at an engine controller within the aircraft to mention two examples. The commands typically cause one or more electronic control signals to be produced and the control signals alter the operation of engine components such as by actuating or adjusting a valve or switch. Generally, when a pilot or aircraft engine controller issues a command to cause the transmission of a control signal to an aircraft component, there is a delay in the component's response to the control signal. Additionally, there can be a delay in the overall engine response due to the inherent reliance on combustion for changes in engine speeds and thus engine thrust. Unfortunately, the delay can adversely affect the engine's performance.

### BRIEF DESCRIPTION OF DRAWINGS

Various needs are at least partially met through provision of the method and apparatus for managing the operation of electrical machines in a turbine engine described in the following detailed description, particularly when studied in conjunction with the drawings. A full and enabling disclosure of the aspects of the present description, including the best mode thereof, directed to one of ordinary skill in the art, is set forth in the specification, which refers to the appended figures, in which:

FIG. 1A depicts an example block diagram of a gas turbine system in accordance with some embodiments;

FIG. 1B depicts an example functional diagram of the system in FIG. 1A in accordance with some embodiments;

FIG. 2 is an architectural diagram showing one example implementation of the system of FIG. 1A or FIG. 8 in accordance with some embodiments;

FIG. 3 is an architectural diagram showing one example implementation of the system of FIG. 1A or FIG. 8 in accordance with some embodiments.

FIG. 4 is an architectural diagram showing one example implementation of the system of FIG. 1A or FIG. 8 in accordance with some embodiments;

FIG. 5 is an example flow chart of a cost function analysis in accordance with some embodiments;

FIG. 6 illustrates response signals of the system of FIG. 1A in accordance with some embodiments;

FIG. 7 illustrates a response signal of the system of FIG. 1A in accordance with some embodiments;

FIG. 8 is an example flow diagram in accordance with some embodiments;

FIG. 9A illustrates the effect of using an electric machine in compensating for the phase loss condition in an engine in accordance with some embodiments;

FIG. 9B is a bode plot illustrating the effect of using one or more electric machines in compensating for the phase loss condition in an engine in accordance with some embodiments; and

FIG. 10 shows a flow diagram of an example method in accordance with some embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments. Also, common but well-understood elements that are useful or necessary in a commercially feasible embodiment are often not depicted in order to facilitate a less obstructed view of these various embodiments. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking and pursuant to various embodiments, systems, apparatuses and methods are provided herein that are useful for leveraging electric power to recover from phase loss conditions. The approaches described herein incorporate an electric power controller to assist operation of the engine during the early stages of a transient condition (e.g., where a component being activated and where lags or delays are prevalent). In some embodiments, a transient delay may be caused by the innerworkings of the various electrical and mechanical components cooperatively working to respond to a command (or demand) requested by the controller, pilot, or other entity. For example, in fuel systems, such delays may arise in the combustion system, fuel transport system, and/or fuel conditioning system of an aircraft, to name a few examples.

The approaches provided herein may need to use additional electric power only during the early stages of the transient (e.g., engine activation) such that only minimal additional power is required and the interactions between primary effector control and electric power control are minimized. As such, a predetermined initial trajectory of a controlled parameter can shape and control the electric power input, benefiting engine operational parameters such as thrust, speed, and/or temperature, to name a few examples. In some embodiments, the approaches provided herein integrate the electric machine with the controller to reduce initial phase loss and improve overall response time of the engine to the pilot's demand. This integration reduces phase loss because the transient delay caused by the innerworkings of the various electrical and mechanical components cooperatively working to respond to a command (or demand) is at least minimized (in some examples, eliminated).

In an illustrative non-limiting example, a gas turbine system may (1) detect a combustor phase loss condition based on a sensed change of a target engine parameter; (2) increase a power supplied by the electric machine in response to detection of the combustor phase loss condition while simultaneously controlling the fuel system according to the sensed change of the target engine parameter; and (3) in response to a measured target engine parameter meeting a desired target engine parameter, reduce the power supplied by the electric machine to a base power.

More specifically, during a starting process, period, or time of a gas turbine engine, a pilot of the aircraft may activate a starter motor (e.g., by moving a lever or pressing an actuator), which is connected to the engine's compressor blades, causing the engine's compressor blades to turn or spin, allowing air to be drawn into a compressor chamber and compressed, then mixed with fuel and ignited, causing the engine to start. In aspects, there is a delay between the demand to activate the starter motor until the time the engine's compressor blades actually start spinning. The approaches provided are directed to compensating for (e.g., eliminating or reducing) the delay. In some embodiments, additional power from the electric machine may be provided to compensate for the delay. In this case and in one example, the starter motor is controlled to increase its initial speed during the initial engine startup period, for instance, by applying more power to the starter motor during the initial startup period. In other aspects, the system may determine how effective the additional power is in compensating for the delay based upon analyzing sensor data received from the sensor/s associated with target parameters. The target parameters are parameters that provide information to the controller to determine the overall system response to the demand. In some embodiments, the controller may execute a cost function analysis to adjust the system response until the demand is met. For example, the controller may increase or decrease the amount of power provided to the starter motor.

Advantageously, the approaches presented herein integrate the operation of electrical machines with the operation of engine controllers. This integration provides several advantages. For example, a higher bandwidth is preserved and/or there is a higher response control for systems with higher phase losses. Another advantage is there is a more uniform acceleration capability along with improvements on the engine's responsiveness to the aircraft pilot. Further, the delay caused by servo draw is compensated, thereby, reducing impact on critical parameter response. Another advantage in integrating the operation of electrical machines with the operation of engine controllers is when a pilot initiates a takeoff burst. In an illustrative non-limiting example, a pilot may proceed with takeoff at higher speeds despite a burst tire. In some embodiments, the electric machine may inject power to the desired engine shaft to ensure that the aircraft generates enough lift to safely take off with a burst tire.

The following description is not to be taken in a limiting sense, but is made merely for the purpose of describing the general principles of exemplary embodiments. Reference throughout this specification to “one embodiment,” “an embodiment,” “some embodiments”, “an implementation”, “some implementations”, “some applications”, or similar language means that a particular feature, structure, or characteristic described in connection with the embodiment is included in at least one embodiment of this disclosure. Thus, appearances of the phrases “in one embodiment,” “in an embodiment,” “in some embodiments”, “in some implementations”, and similar language throughout this specification may, but do not necessarily, all refer to the same embodiment.

In some embodiments, a gas turbine engine includes a fuel system providing fuel to a combustor coupled to an engine shaft. The gas turbine engine may include an electric machine coupled to supply torque to the engine shaft. In some embodiments, the gas turbine engine includes a main controller coupled to the electric machine and/or the fuel system. In some embodiments, the main controller detects a combustor phase loss condition based on a sensed change of a target engine parameter. In response to the detection of the combustor phase loss condition while simultaneously controlling the fuel system in accordance with the sensed change of the target engine parameter, the main controller may increase a power supplied by the electric machine. In some embodiments, the main controller reduces the power supplied by the electric machine to a base power in response to a measured target engine parameter meeting a desired target engine parameter.

In some embodiments, a method for gas turbine engine includes detecting, by a main controller coupled to an electric machine and a fuel system, a combustor phase loss condition based on a change of a target engine parameter. The method may include increasing, by the main controller, a power supplied by the electric machine in response to detection of the combustor phase loss condition while simultaneously controlling the fuel system according to the change of the target engine parameter. In some embodiments, the fuel system provides fuel to a combustor, and the electric machine supplies torque to an engine shaft. The methods may include reducing, by the main controller, the power supplied by the electric machine to a base power in response to a measured target engine parameter meeting a desired target engine parameter.

The foregoing and other benefits may become clearer upon making a thorough review and study of the following detailed description.

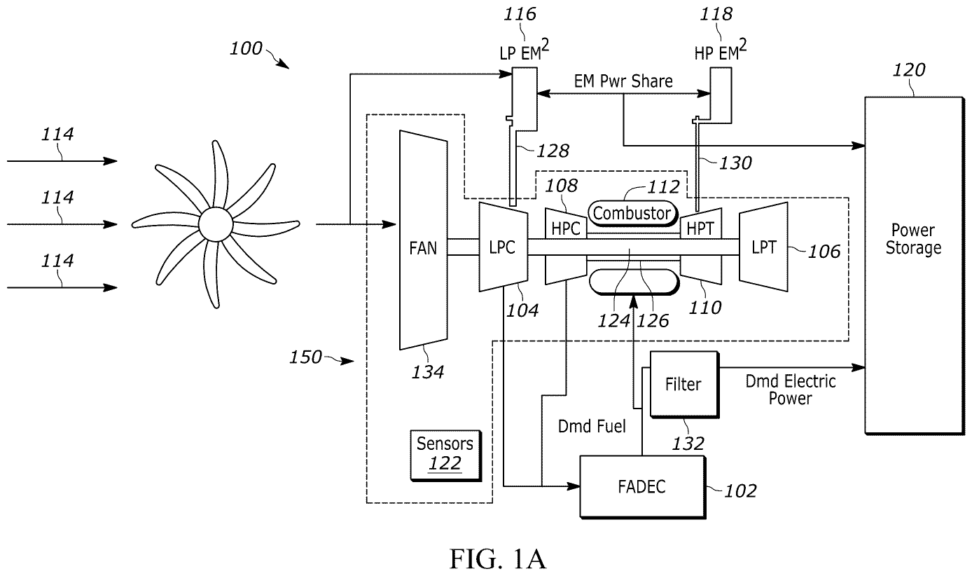

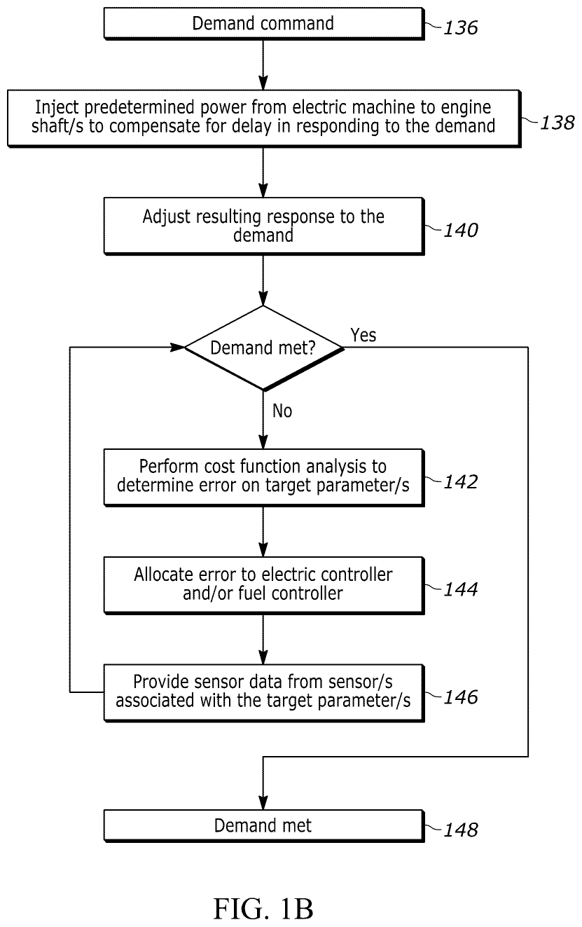

FIG. 1A depicts a block diagram of a system 100 including a gas turbine engine 150 in accordance with some embodiments. The system 100 includes a low pressure compressor (LPC) 104 coupled to a low pressure turbine (LPT) 106 via a low pressure shaft 124, a high pressure compressor (HPC) 108 coupled to a high pressure turbine (HPT) 110 via a high pressure shaft 126, and/or a combustor (also referred to as a burner or a combustion chamber) 112. For example, the LPC 104 compresses air 114 at low pressure. The air 114 is then further compressed in the HPC 108 and mixed with fuel and ignited in the combustor 112. The resulting hot gases spin or turn the HPT 110 which powers the HPC 108. In some embodiments, the remaining energy in the gases spins or turns the LPT 106 which powers the LPC 104 and fan 134 to generate engine thrust.

The system 100 includes a main controller (e.g., a full authority digital engine control (FADEC) controller) 102. In some embodiments, the main controller 102 may be any microcontroller, computer, or processor-based device with processor, memory, and programmable input/output peripherals, which is generally designed to govern the operation of other components and devices of an aircraft. In some embodiments, it may be further understood to include common accompanying accessory devices, including memory, transceivers for communication with other components and devices, etc. These common accompanying accessory devices options are well known and understood in the art and require no further description here.

The main controller 102 may be configured (for example, by using corresponding programming stored in a memory as will be well understood by those skilled in the art) to carry out one or more of the steps, actions, and/or functions described herein. The main controller 102 may include a memory that includes computer instructions that implement any of the functions described herein.

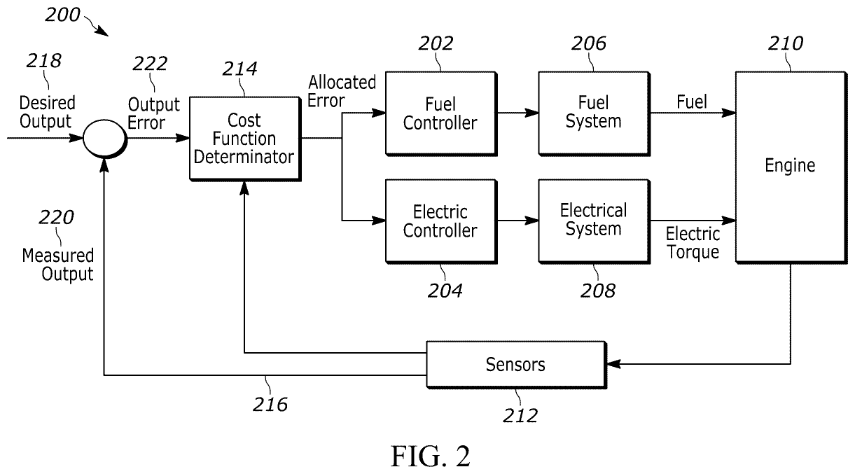

In some embodiments, the system 100 may include a filter 132. For example, the filter 132 may receive a value from the main controller 102. In some embodiments, the value is output by the filter 132 in response to an execution of the compute cost analysis described herein. The purpose of the filter 132 is to decouple the transient responses of the electric machine and gas turbine engine primary effectors (e.g., ailerons, elevators, rudder, to name a few) to ensure stable operation. Alternatively or in addition, the filter 132 may output the filtered value to an electric controller (e.g., electric controller 204 of FIG. 2). In some embodiments, the filtered value may correspond to a value recognized and/or actionable by the fuel controller 202.

Additionally, the system 100 includes an electric machine. For example, the electric machine may be an electric motor and include an electric machine controller. In some embodiments, the electric machine controller manages the operation of the electric motor, primarily controlling its speed, direction, and torque by regulating the power supplied to it. In some embodiments, an electric machine is implemented as a low pressure electric machine (LPEM) 116 that is coupled to the LPC 104. In some embodiments, the LPEM 116 provides injects power to the LPC 104 via rotation or application of torque to a mechanical shaft 128 that is coupled to the low pressure shaft 124 during an early portion of a transient during which a lag/delay is most common. For example, a range of time that lag/delay is most common includes 0.5 to 2 seconds for variable geometries and/or 0.5 to 5 seconds for combustion translated to significant rotational speed of the core and/or fan shaft, to name a few.

Alternatively or in addition, an electric machine can be implemented by high pressure electric machine (HPEM) 118 that is coupled to the HPC 108. In some embodiments, the HPEM 118 provides or injects power to the HPC 108 via rotation or application of torque to a mechanical shaft 130 that is coupled to the high pressure shaft 126 during an early portion of the transient during which the lag/delay is most common. In some embodiments, power may be injected separately and/or simultaneously to the HPC 108 and LPC 104 based on a control signal from the main controller 102. In some embodiments, the separate mechanical shafts 128, 130 supply torque to the engine when a corresponding electric machine operates in torque mode. In some embodiments, the separate mechanical shafts 128, 130 supply torque from the engine to a corresponding electrical machine when the electrical machine operates in voltage mode.

In other aspects, the system 100 includes one or more sensors 122 coupled to the LPC 104 and/or the HPC 108. The one or more sensors 122 may sense one or more of the speed of the low pressure shaft 124 and/or the high pressure shaft 126, the engine pressure ratio, the torque produced by the low pressure and/or high pressure shafts 124, 126, and the amount of thrust the engine produces. Other parameters may also be sensed. In one specific example, the one or more sensors 122 are configured to sense and provide inlet and exit air pressure data used in determining the engine pressure ratio (EPR) to measure thrust. In some embodiments, the one or more sensors 122 may be configured to provide turbine outlet temperature data used in determining exhaust gas temperature (EGT) to gauge engine health.

Alternatively or in addition, the system 100 includes power storage 120 operatively coupled to the main controller 102 and the LPEM 116 and/or the HPEM 118. The power storage 120 may be coupled to one or more aircraft components that generally demand power while the aircraft is in operation. For example, the main controller 102 may send control signals demanding or causing the power storage 120 to provide power to one or more of these aircraft components. In some embodiments, the power storage 120 may draw power from the LPEM 116 and/or the HPEM 118. In some embodiments, the power storage 120 may be a rechargeable battery capable of being recharged and/or output power when demanded. Other forms of power storage devices are possible.

FIG. 1B depicts a functional diagram showing aspects of the operation of the system in FIG. 1A. In an illustrative non-limiting example, at step 136, the system 100 receives an indication of a demand (e.g., in the form of or included with an electronic command from the cockpit) to start a gas turbine engine.

The main controller 102, at step 138, causes an electric machine (e.g., the LPEM 116 and/or the HPEM 118) to inject a predetermined amount of power into an engine shaft (e.g., the low pressure shaft 124 and/or the high pressure shaft 126) to compensate for the delay in the system response to the indication of a demand. The amount of power being injected is determined by the cost function analysis described herein. In some embodiments, a competing cost function is used to ensure that the net electric power returns back to the original state (i.e., net power=required power from internal/external loads−additional power from the main controller) such that electric power will automatically be reduced as the other cost functions start to reach their set points. For example, the cost function may include the engine CTQ (Critical to Quality) like acceleration (final target thrust−starting target thrust) competing with netpower returning to its original state on the electric machines. The engine CTQ may correspond to particular characteristics or attributes of an engine that are most important to its functionality and performance, directly impacting customer satisfaction and considered crucial for the overall quality of a vehicle of the aircraft, such as the key aspects of an engine of the aircraft that need to be closely monitored and controlled to ensure optimal operation as exemplified above.

At step 140, the main controller 102 detects a combustor phase loss condition based on a change of a target engine parameter. By a “phase loss condition” and as used herein, it is meant the delay/lag between the time a demand is commanded to the time a response to the demand is detected.

At step 140, the system 100 adjusts the resulting response to the indication of the demand. For example, the main controller 102 increases a power supplied by the electric machine (e.g., the LPEM 116 and/or the HPEM 118) in response to detection of the combustor phase loss condition while simultaneously controlling a fuel system (e.g., the fuel system 206 of FIGS. 2-4) to adjust or fine tune the response to the demand according to the change of the target engine parameter. In examples, the fuel system provides fuel to a combustor, and the electric machine supplies torque to an engine shaft. Step 140 also determines if the demand has been met. If the demand is met, execution continues with step 148 as described below. If the demand is not met, steps 142, 144, and 146 are executed.

To determine the amount of fuel provided and the amount of power output by the electric machine, the system 100, at 142, performs a cost function analysis to determine error values associated with one or more target parameters. The error values represent the differences between the desired value of the target parameter and the measured/observed value of the target parameter. In some embodiments, the error values represent the differences between the desired value of the target parameter and the estimated value of the target parameter. By “cost function analysis” and is used herein, an error analysis is performed to determine the amount of error between the difference in values of the desired and measured/observed/estimated target parameters and the net electric power as described herein. For example, the net power refers to the required electrical power to support internal and external loads minus the additional power consumed by this change in power output to reduce phase loss. As mentioned, one or more error values may be output by the cost function analysis. The system 100, at step 144, allocates error values to the electric controller 204 and/or the fuel controller 202. Control data or control signals may include, incorporate, or represent the error values and these can be transmitted to the electric controller 204 and/or the fuel controller 202. Once received by the electric controller 204 and/or fuel controller 202, the amount of fuel and/or amount of power provided by the fuel system 206 and/or electrical system 208 is controlled according to the error value. For example, the electrical and/or mechanical operation of valves, switches, or other components within these systems are adjusted.

At step 146, the system 100 provides sensor data from one or more sensors 122 associated with the target parameters as a feedback response to a processor (e.g., the main controller 102), which may perform the cost function analysis starting back at step 142 until the demand is met.

The system 100, at step 148, has determined that the demand has been met and execution may end. Alternatively or in addition, in response to detecting that a measured target engine parameter meets a desired target engine parameter, the main controller 102 reduces the power supplied by the electric machine to a base power and the execution of the cost function analysis ends.

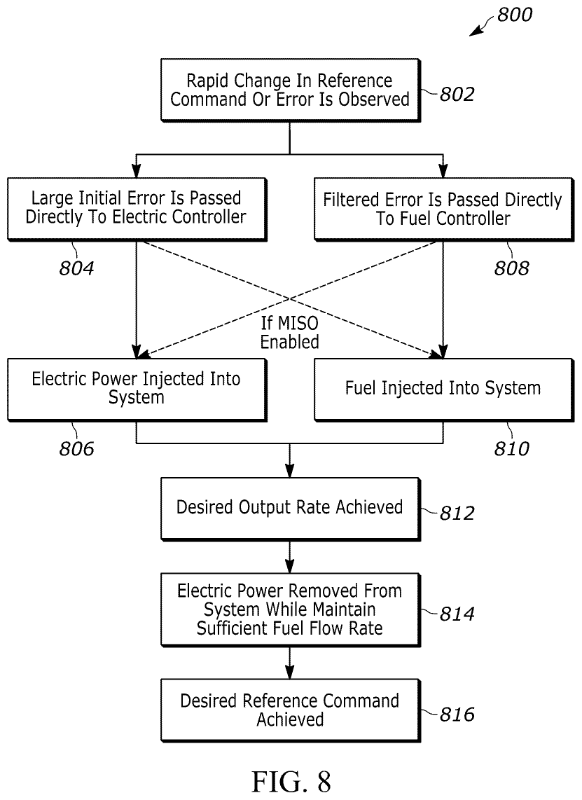

FIGS. 2-4 are architectural diagrams showing examples of specific system configurations that implement the functional diagram of FIG. 1A and/or the flow diagram of FIG. 8. Other examples are possible.

For example, in FIG. 2, an example single input/single output (SISO) system 200 is shown. In some embodiments, one or more elements shown in FIG. 2 may be associated with and/or function in cooperation with one or more elements shown in FIGS. 1A and 1B. For example, the main controller 102 (of FIG. 1A) may be operatively coupled to and/or in communication with a fuel controller 202 and/or an electric controller 204. In some other embodiments, the same electric controller 204 may manage operation of the LPEM 116 and/or the HPEM 118. In some other embodiments, each of the LPEM 116 and the HPEM 118 may be managed separately by a corresponding electric controller 204. In some additional embodiments, the main controller 102 may include an electric controller 204 of an electric machine and a fuel controller 202 of a fuel system.

The SISO system 200 includes a fuel controller 202 and/or an electric controller 204. Alternatively or in addition, the SISO system 200 may include a fuel system 206 coupled to the fuel controller 202 and/or an electrical system 208 coupled to the electric controller 204. The SISO system 200 includes an engine 210. In some embodiments, the engine 210 includes the LPC 104 coupled to the LPT 106 via the low pressure shaft 124, the HPC 108 coupled to the HPT 110 via the high pressure shaft 126, and/or the combustor 112 described in FIG. 1A. The SISO system 200 also includes one or more sensors 212 (e.g., sensors 122 of FIG. 1A). In some embodiments, the one or more sensors 212 are sensors configured to capture or obtain sensed data of one or more components of the engine 210 in order for the main controller 102 to determine, detect, or sense change in one or more target engine parameters as described herein.

In some embodiments, the fuel system 206 may include fuel tanks, fuel lines, fuel pumps, fuel filters, fuel gauges, fuel selector valves, cross feed valves, and/or other components required to store, transport, and/or delivery fuel to the engine 210, allowing a pilot to manage fuel distribution across different tanks and to the engine 210 as needed. In some embodiments, the electrical system 208 may include a battery, a generator or alternator (to produce electricity), an electrical bus to distribute power, and/or circuit protection devices like fuses or circuit breakers to safeguard the system from overloads and short circuits.

The SISO system 200 additionally includes one or more storage memory devices (e.g., a random access memory, a read only memory, a hard disk drive, a solid state drive, a network attached storage, and/or any type memory storage devices capable of storing electronic data) configured to store instructions or computer code corresponding to cost function analysis (as described herein) executed by the main controller 102 to control the power supplied by the LPEM 116 and/or the HPEM 118 to the respective low pressure shaft 124 and/or high pressure shaft 126.

A cost function determinator 214 may include or be implemented as computer code and/or electronic instructions to perform the cost function analysis described herein. In some embodiments, the computer code and/or electronic instructions are stored in a memory storage device (not shown) and executed by the main controller 102. In some embodiments, in executing the cost function analysis, the main controller 102 may decide when and how much electric power to use by employing a competing cost function strategy to weigh multiple controller objectives. For example, the main controller 102 may determine that it may be desirable to move the shaft velocity (accelerate rate) rapidly. For example, in comparing the desired rate of shaft acceleration (e.g., at 218) with the observed or measured rate of shaft acceleration (e.g., at 220), the main controller 102 may determine the difference (e.g., 222), NdotError (i.e., NdotError=Desired Rate−Observed Rate). In response, the main controller 102 may send control data or signals corresponding to a portion of the difference to the electric controller 204 causing one or more components of the electrical system 208 to quickly ramp up the electric power output by the electric machine (e.g., LPEM 116 and/or HPEM 118) to increase the velocity of the shaft, reducing the NdotError. For example, an electric machine (e.g., the LPEM 116 and/or HPEM 118) may receive the control data or signals and actuate the electric motor to cause a shaft (e.g., LP shaft 124 and/or HP shaft 126) to increase rotation. Alternatively or in addition, the main controller 102 may send control data or signals corresponding to the remaining portion of the difference to the fuel controller 202 causing one or more components of the fuel system 206 to provide additional fuel affecting the engine pressure ratio. For example, a fuel injector (not shown) may be actuated in part based on the control data or signals to inject addition fuel in the combustor 112. In some embodiments, the competing cost function strategy is preprogrammed (stored in a memory storage (not shown)) based on operating envelope condition and desired transient (i.e., size of thrust command, takeoff vs climb maneuver etc.) and based on the estimated available operability headroom in the compressor to mitigate stall concerns.

In some embodiments, a competing cost function is used to ensure that the net electric power returns back to the original state (i.e., net power=required power from internal/external loads−additional power from electric controller) such that electric power may automatically be reduced as the other cost functions start to reach their set points (i.e., as NdotError approaches zero, electrical power may gradually be removed to satisfy cost function of achieving original net power). For example, the net power corresponds to the power generally demanded by the internal/external loads of a conventional system (that is, a system where the electric machine is not integrated with the main controller of the engine). In some embodiments, the main controller 102 may continuously execute the cost function analysis until the desired rate of shaft acceleration is substantially equal to the observed or measured rate of shaft acceleration. Although the above example discusses engine acceleration, other parameters may be used in the cost function analysis. In some embodiments, the electric controller 204 may initially alter the engine response gradually rather than immediately. Additional details of the cost function analysis is provided below.

In some embodiments, the main controller 102 may detect, measure or sense change of a target engine parameter (e.g., the amount of thrust produced by the engine, the speed of the low pressure shaft 124 and/or the high pressure shaft 126, the engine pressure ratio, the torque produced by the low pressure shaft 124 and/or the high pressure shaft 126, and/or the engine power) by capturing or obtaining the sense data output from one or more corresponding sensors 212. The main controller 102 may compare the measured value of the target engine parameter with the desired value of the target engine parameter, and output corresponding control data or a control signal to the fuel controller 202 and/or the electric controller 204 in accordance with the result of the comparison. In some embodiments, a desired target engine parameter includes a thrust or a speed of an engine shaft, a pressure ratio of a high compressor and a low compressor of a gas turbine engine, a torque supplied to the engine shaft, and/or a power supplied to the gas turbine engine. In some embodiments, the desired target engine parameter may be based on an input commanded by a user.

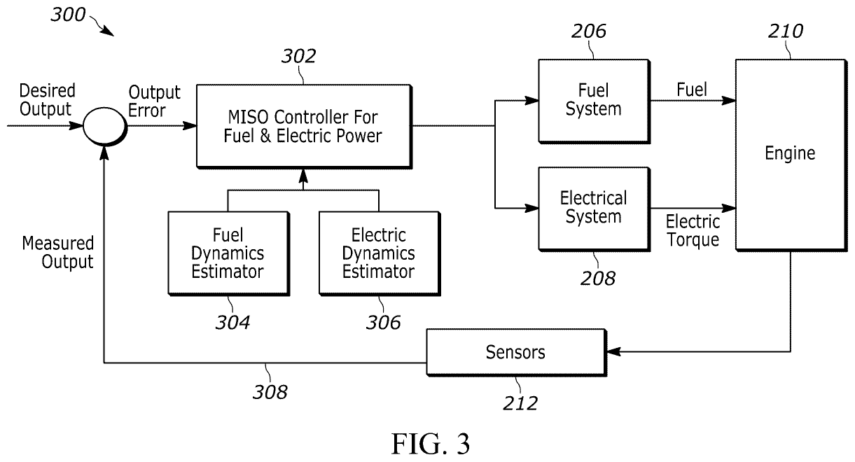

FIG. 3 depicts an example multiple input/single output (MISO) system 300. In some embodiments, one or more elements shown in FIG. 3 may be associated with and/or function in cooperation with one or more elements shown in FIGS. 1A and 1B and/or FIG. 2. For example, one or more elements of the MISO system 300 may correspond to and/or function similar to the elements of the SISO system 200. For example, the fuel system 206, the electrical system 208, the engine 210, and/or the one or more sensors 212 may correspond to the respective elements in FIG. 2.

In some embodiments, the fuel controller 202 and the electric controller 204 in MISO system 300 are integrated in a single MISO controller 302 as shown. That is, the hardware and the software of each element are physically combined into a single element. Alternatively or in addition, a fuel dynamics estimator 304 and/or an electric dynamics estimator 306 are subcomponents in the MISO controller 302 each configured to estimate the corresponding control data to cause the fuel system 206 and/or the electrical system 208 to respectively increase and/or decrease the fuel and/or the power supplied in order to meet or satisfy the command received by the main controller 102. The term “command” is sometimes referred to herein as a “reference command” and refers to an electronic signal or message that is requesting that a specific engine operation is to be performed requiring the control or adjustment of one or more engine components. In some embodiments, the command may be associated with one or more actions performed by the pilot of the aircraft (e.g., by pushing the throttle to increase the power to the engine of the aircraft, pulling the throttle to decrease the power, causing the ailerons to raise or lower the wings of the aircraft, to name a few). In some embodiments, the cost function analysis described herein may be executed by the MISO controller 302.

In some embodiments, the fuel dynamics estimator 304 and the electric dynamics estimator 306 each correspondingly calculate the estimated transfer function between the effector and the desired output to control, such as the lag between using fuel to produce thrust (calculated by the fuel dynamics estimator 304) versus the lag to use electric power to produce thrust (calculated by the electric dynamics estimator 306) and how much is available before that effector is saturated. For example, the estimated transfer function is calculated either offline or predetermined based on knowledge of the hardware (e.g., fuel metering valve and bypass valve dynamics or any other fuel system dynamics) and a pre-estimated delay associated with combustion determined from testing. Alternatively, the estimated transfer function can be learned online from directly measuring and tracking the lag from the time a command is issued on the fuel system and/or electric system and the time that a noticeable change in the output (i.e., thrust) is observed.

In some embodiments, the multi input single output (MISO) system 300 allows for a consensus control over the desired output. The impact of either the fuel system or the electric system on the desired output is taken into account for commands to both effectors allowing a smoother and more precise control scheme. In some embodiments, the single input single output (SISO) is less complex and can be advantageous to decouple the two effector loops if the preference is to have them run at different bandwidths.

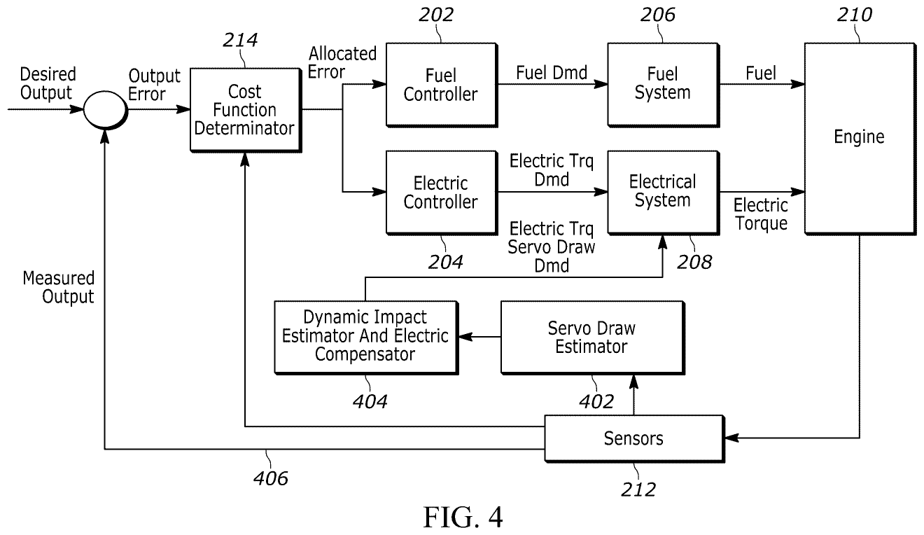

FIG. 4 depicts an example block diagram illustrating a servo draw impact reduction of a SISO system 200 of FIG. 2. In some embodiments, one or more elements shown in FIG. 4 may be associated with and/or function in cooperation with and/or function similar to one or more elements shown in FIG. 1A and/or FIG. 2. As used herein, “servo draw” refers to fuel being pulled away from the primary combustion path to drive hydraulically driven actuators that use the same fuel for architectures that don't have separate dedicated actuation pumps.

For example, the fuel controller 202, the electric controller 204, the fuel system 206, the electrical system 208, the engine 210, and/or the one or more sensors 212 may correspond to the respective elements in FIG. 2. FIG. 4 differs from FIG. 2 in that FIG. 4 illustrates additional components (e.g., a dynamic impact estimator and electric compensator 404 and/or a servo draw estimator 402) used to provide additional compensation to the delay attributable to the use of servomotor (not shown) in the aircraft. In some embodiments, as shown in FIG. 4, the SISO system 200 may include a dynamic impact estimator and electric compensator 404 and/or a servo draw estimator 402 as shown. For example, the servo draw estimator 402 may be initiated by the main controller 102 to determine an estimated value of impact caused by the servo draw to the target engine parameter. Alternatively or in addition, the output of the servo draw estimator 402 is fed into a dynamic impact estimator and electric compensator 404 to determine an increase and/or decrease of the power supplied by the LPEM 116 and/or the HPEM 118 to the respective low pressure shaft 124 and/or high pressure shaft 126 in order to meet or satisfy the reference command received by the main controller 102.

For example, the servo draw estimator 402 estimates the fuel pulled away from the primary combustion path to drive hydraulically driven actuators that use the same fuel for architectures that don't have separate dedicated actuation pumps. In some embodiments, a servo draw model can predict the amount of fuel diverted away from the combustor and, using the bypass valve specification describing its dynamics, can estimate the disturbance in speed/thrust to, for example, boost speed simultaneously to avoid any speed/thrust droop effect. In some embodiments, based on the rate of change of any fuel hydraulic valves, the dynamic impact estimator and electric compensator 404 may estimate the amount of fuel drawn from the main combustor and estimate the resulting droop on the desired output (e.g., speed, thrust, to name a few) and then compensate with a delta to the electric torque demand to try and keep the speed or thrust from drooping.

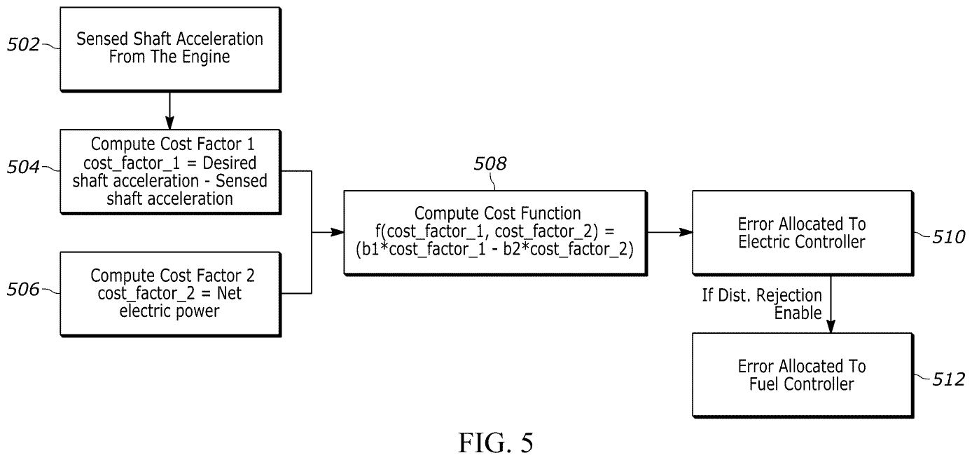

FIG. 5 is a flow chart showing one example approach for performing the cost function analysis described herein. In this example, the main controller 102 receives a demand command. In some embodiments, the demand command may be associated with one or more actions performed by the pilot of the aircraft (e.g., by pushing the throttle to increase the power to the engine of the aircraft, pulling the throttle to decrease the power, causing the ailerons to raise or lower the wings of the aircraft, to name a few). In some embodiments, the demand command may cause the low pressure shaft 124 and/or the high pressure shaft 126 to increase the speed.

The main controller 102, at step 502, senses the acceleration of the low pressure shaft 124 and/or the high pressure shaft 126. To determine the corresponding control data to send to the fuel controller 202 and/or the electric controller 204, the main controller 102 and/or the MISO controller 302 execute the cost function analysis.

At step 504, the cost function analysis includes computing cost factor 1. For example, in computing the cost factor 1, a difference between the sensed data associated with the desired shaft acceleration and the sensed shaft acceleration may be determined by the main controller 102 and/or the MISO controller 302 based on the sensed data output by the corresponding sensors 212. The cost function analysis, at step 506, includes computing cost factor 2. For example, in computing the cost factor 2, the net electric power may be determined by the main controller 102 and/or the MISO controller 302. Alternatively or in addition, the cost function analysis may include the state of the engine and/or the final desired state (i.e., difference between the desired final thrust and current estimated thrust or speed).

Alternatively or in addition, the main controller 102 may detect the combustor phase loss condition by determining a difference between a first cost factor (e.g., the cost factor 1) and a second cost factor (e.g., the cost factor 2). In some embodiments, the first cost factor may include a difference between the value associated with a desired target engine parameter and the value associated with a measured target engine parameter. Alternatively, the first cost factor may include a difference between the value associated with a desired target engine parameter and the value associated with an estimated engine parameter. In some embodiments, the second cost factor may include a net electric power demanded to the electric machine. Alternatively or in addition, in detecting the combustor phase loss condition, the main controller 102 may execute a compute cost algorithm to determine the difference between the first cost factor and the second cost factor. Alternatively or in addition, the main controller 102 may output a value to an electric controller 204 of the electric machine. In some embodiments, the value may determine whether the power supplied by the electric machine is increased or reduced.

At step 508, the cost function analysis includes computing the cost function. For example, in computing the cost function, a difference between a weighted cost factor 1 and a weighted cost factor 2 is determined by the main controller 102 and/or the MISO controller 302. Alternatively or in addition, the main controller 102 and/or the MISO controller 302 may send control data to the fuel controller 202 and/or the electric controller 204 to increase and/or decrease power supplied by the LPEM 116 and/or the HPEM 118 to the respective low pressure shaft 124 and/or high pressure shaft 126 in order to meet the reference command transmitted by the main controller 102 to the engine 210.

For example, at step 510, the main controller 102 and/or the MISO controller 302 may provide control data (also referred to as error) to the electric controller 204. Alternatively or in addition, at step 512, the main controller 102 and/or the MISO controller 302 may provide control data or a control signal to the fuel controller 202. In some embodiments, the control data or the control signal may be provided to the fuel controller 202 to reject disturbances on the desired controlled parameter output at step 508 if the disturbances rejection is enabled. Although the above example discusses shaft acceleration, the cost function analysis is applicable to other parameters (e.g., fan speed, core speed, thrust, pressure ratio, to name a few).

In an illustrative non-limiting example, if a shaft (e.g., the low pressure shaft 124 and/or the high pressure shaft 126) acceleration mismatch is determined by the main controller 102 and/or the MISO controller 302 to be a greater cost factor at any given point in time, the error allocated to the electric controller 204 may drive the net power to be greater than zero (0) to achieve the desired speed of the shaft. Alternatively or in addition, if a non-zero net electric power is determined to be a greater cost, the error may drive the net power towards the nominal power load. For example, if the cost factor NdotError (i.e., NdotError=desired target engine parameter−observed/measure target engine parameter) is greater than the cost factor net power (i.e., net power=required power load−power from electric machine), which corresponds to the power demanded by the aircraft excluding the power demanded by the electric machine, the main controller 102 may increase the power supplied by the electric machine to the shaft. In another example, if the cost factor NdotError is less than the cost factor net power, the main controller 102 may decrease the power supplied by the electric machine to the shaft.

In some embodiments, the above are determined by the main controller 102 and/or the MISO controller 302 based on a cost function as defined below:
Cost_Factor_1=Difference Between Desired and Sensed Shaft Acceleration
Cost_Factor_2=Net Electric Power
w1, w2=weighting factors to account for difference in units between the Cost_Factor_1 and the Cost_Factor_2.

In some embodiments, weighting factors can be determined based on analysis that produces best results with some level of normalizing accounted for where that normalization factor would be determined based on the maximum range of each parameter (i.e., 1/(maxDifferenceInAccelerationError) or 1/(maxNetPower)).

In another illustrative non-limiting example, if a MISO system or an integrated control architecture is used as described herein (e.g., SISO system 200 of FIGS. 2 and 4 and/or MISO system 300 of FIG. 3), the electric controller 204 response may be used by the fuel controller 202 to reject disturbances on the desired controlled parameter output. For example, the main controller 102 may detect a combustor phase loss condition (that is, a delay greater than a predetermined threshold) is detected from the time it received a reference command to the time a response is determined from a target engine parameter. In some embodiments, a phase loss condition may correspond to a time delay from when a demand to the system is received to the time a response is detected by the system. In some embodiments, the main controller 102 may increase power supplied by the electric machine in response to detection of the combustor phase loss condition while simultaneously controlling the fuel system. For example, the main controller 102 may execute the cost function analysis as described in FIG. 5 to determine the error to allocate to the electric controller 204 and/or the fuel controller 202. In some embodiments, the main controller 102 may periodically determine whether the measured target engine parameter meets or satisfy the desired target engine parameter. For example, the desired target engine parameter may include at least one of a thrust or a speed of the engine shaft, a pressure ratio of a high compressor and a low compressor of the gas turbine engine, the torque supplied to the engine shaft, and/or a power supplied to the gas turbine engine.

Alternatively or in addition, in response to the measured target engine parameter meeting or satisfying the desired target engine parameter, the main controller 102 may reduce the power supplied by the electric machine to a base power. In some embodiments, the base power may correspond to the power generally required to operate the aircraft without having to account for the phase loss condition (e.g., aircraft loads and domestic load internal to the engine). In some embodiments, the base power corresponds to a default power demanded by an aircraft to the gas turbine engine. For example, the main controller 102 may determine that the NdotError is less than the cost factor net power. In such an example, the main controller 102 may decrease the power supplied by the electric machine.

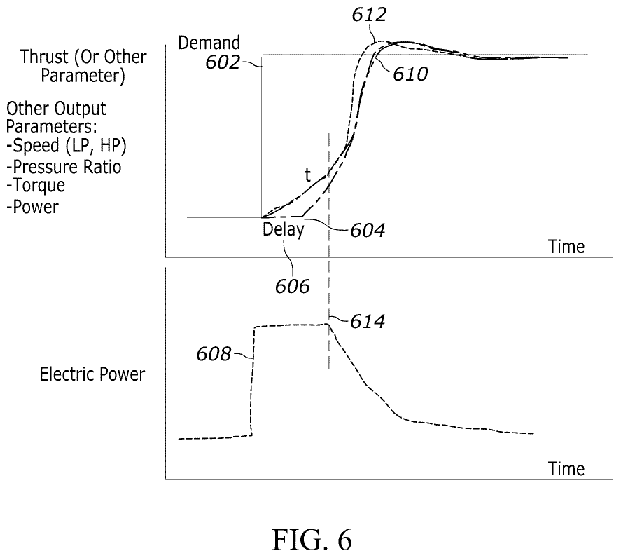

FIG. 6 is a graph that illustrates the advantages of an LPEM 116 and/or an HPEM 118 integrated with a main controller 102 of an engine 210. In some embodiments, the main controller 102 receives a demand command. In an illustrative non-limiting example, the demand command corresponds to a demand step function 602 shown in FIG. 6. In a first system (that is, a system that does not have a LPEM 116 and/or a HPEM 118 integrated with a main controller 102 of an engine 210), a response to the demand is exemplified by the response signal 604 shown in FIG. 6. The response signal 604 includes a delay 606 due to a phase loss condition. By a “phase loss condition”, it is meant the delay/lag between the time a demand is commanded to the time a response to the demand is detected. However, the system 100 of FIG. 1A and the SISO system 200 and the MISO system 300 of FIGS. 2-4 mitigate the delay 606 by the LPEM 116 and/or the HPEM 118 supplying power (e.g., the electric power signal 608) to the respective low pressure shaft 124 and/or high pressure shaft 126 of the engine 210. In some embodiments, the response signal 610 may correspond to a response of the SISO system 200. In some embodiments, the response signal 612 may correspond to a response of the MISO system 300 of FIG. 3. As illustrated, the delay 606 is not present in both the response signal 610 and the response signal 612. In particular, at the time of the demand 602, the thrust of the response signals 610, 612 immediately starts to increase.

In an illustrative non-limiting example, during a step-response (e.g., the demand step function 602) in which a demanded controlled output has a rapid change in command, there may be some inherent lag/delay in a combustion system (e.g., a gas turbine engine) before a desired response is seen in the output. For example, an independent control algorithm (e.g., a cost function analysis) using electric power injection as an input may offset this initial lag/delay to produce a fast initial rate response in the desired output until combustion energy is sufficient to maintain a desired output rate at which point the electric power can be removed as illustrated at 614. In some embodiments, in a more advanced scheme, the main controller 102 and electric controller 204 are integrated into a MISO system 300 that coordinate objectives such that the overall response is faster as illustrated by the response signal 612.

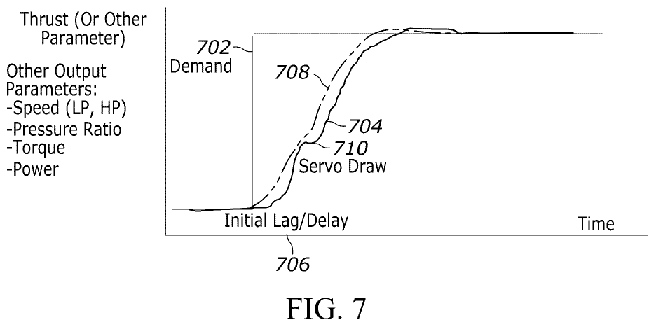

FIG. 7 is a graph that illustrates the advantages of an LPEM 116 and/or an HPEM 118 integrated with a main controller 102 of an engine 210. By “integrated” it is meant that the LPEM 116 and/or an HPEM 118 are working in cooperation with the main controller 102. In some embodiments, the main controller 102 may receive a reference command. In an illustrative non-limiting example, the reference command may correspond to a demand step function 702 shown in FIG. 7. In a system that does not have a LPEM 116 and/or a HPEM 118 integrated with a main controller 102 of an engine 210, a response to the demand is exemplified by the response signal 704 shown in FIG. 7. The response signal 704 includes a delay 706 due to a phase loss condition (that is, the delay between the time a demand is commanded to the time a response to the demand is detected; the delay attributable to the innerworkings of the electrical and/or fuel systems in the aircraft to implement the demand). However, the system 100 of FIG. 1 and the SISO system 200 of FIG. 4 mitigates the delay 706 by the LPEM 116 and/or the HPEM 118 supplying power (e.g., the electric power signal 608) to the respective low pressure shaft 124 and/or high pressure shaft 126 of the engine 210. In some embodiments, the response signal 708 may correspond to a response of the SISO system 200 of FIG. 4. As illustrated, the delay 706 is not present in the response signal 708.

One additional benefit of having an electric machine integrated with the main controller 102 is the reduction of the phase loss associated with servo draw (i.e., the power drawn or demanded by a servo system in the aircraft) on the combustion system. The effect of the servo draw is shown at 710 of the response signal 704 in FIG. 7. At 710, the instantaneous draw of power required by the servo system causes the power provided to the electrical and/or fuel systems in the aircraft to drop causing the rotation of the compressor shaft (e.g., the LP shaft 124 and/or the HP shaft 126) to decrease resulting in additional delay in satisfying the demand. With the integration of the electric machine with the main controller 102, the additional delay caused by the servo draw is eliminated as illustrated by the response signal 708.

For example, for a conventional gas turbine engine combustion system, a single fuel pump may be used for both primary fuel delivered to the combustor and for providing actuation hydraulic fluid. In some embodiments, during transients (e.g., where a component being activated and where lags or delays are prevalent), multiple geometries (e.g., hydraulic pumps) may be moved, which require hydraulic fluid to be pulled off of the main fuel pump, which can adversely affect the primary control response. In some embodiments, the electric power system (that is, the electric machine) described herein may be used when these large, demanded rates of change in variable geometries are detected to counteract the temporary reduction in combusted fuel such that any impact on the desired controller output response (such as those corresponding to the target engine parameters described herein) is reduced.

FIG. 8 is a flow diagram 800 in accordance with some embodiments. In some embodiments, the steps illustrated in the flow diagram 800 are implemented in the system 100 of FIG. 1A, the SISO system 200 and/or the MISO system 300 of FIGS. 2-4.

In an illustrative non-limiting example, a main controller 102 detects a combustor phase loss condition based on a sensed change of a target engine parameter. By a “combustor phase loss condition” it is meant phase loss condition as described herein. For example, the sensed change in the target engine parameter may correspond to a difference between the value associated with the desired target engine parameter and the value associated with the measured target engine parameter. In some embodiments, a target engine parameter may include one or more of thrust produced by the engine, speed of low pressure and/or high pressure shafts, engine pressure ratio, torque produced by the low pressure and/or high pressure shafts, and/or engine power.

At step 802, the main controller 102 detects a rapid change in reference command or an error is observed. For example, the main controller 102 receives a reference command corresponding to an increase of the engine pressure ratio relative to the current engine pressure ratio. In such an example, the reference command may correspond to the demand step function 602 shown in FIG. 6 and/or the demand step function 702 shown in FIG. 7.

In an illustrative non-limiting example, to increase the engine pressure ratio, the main controller 102 may increase the speed of the low pressure and/or the high pressure shafts 124, 126. For example, the main controller 102 may increase a power supplied by the LPEM 116 and/or HPEM 118 in response to a detection of the combustor phase loss condition while simultaneously controlling the fuel system 206 according to the sensed change of the target engine parameter. In some embodiments, the main controller 102 may execute the cost function analysis.

At step 804, the cost function analysis passes a large initial error (e.g., error due to the difference between a desired target parameter value and a measured target parameter value) directly to the electric controller 204. For example, the large initial error may refer to passing most and/or all (e.g., 50-100%) of the observed/measured error in a reference signal (i.e., a response signal associated with the target parameter, such as the response signal 610 and the response signal 612 of FIG. 6 and/or the response signal 708) from feedback signal (e.g., feedback signal 216 of FIG. 2 and/or feedback signal 308 of FIG. 3, and/or feedback signal 406 of FIG. 4) to the main controller 102. In some embodiments, a large initial error may be selected since a large error multiplied by a controller gain may result in a larger commanded change in the electric machine response compared to a small error multiplied by the same gain would give a smaller change in commanded response.

In some embodiments, the filtered error may refer to there being a filter placed on the error signal prior to it being sent to the fuel controller 202. This filter could be a low pass filter designed to shape the fuel controller error. For example, the cost function analysis in FIG. 5 may scale the electric controller error over time as a function of the specific costs discussed herein. As such, in one example, when a large error is observed and no engine acceleration exists, the cost function analysis sets a scalar on the electric controller 204 or the error is passed to the electric controller of 1 (or some other scalar). In some embodiments, as the engine starts to accelerate and the cost function analysis (also referred to herein as a competing cost function) may start to dominate the response, the scalar on the error might be reduced to 0.5, and then to 0, fully cancelling out the electric controller response.

The electric controller 204, at step 806, causes the electric machine to inject electric power into the system 100, the SISO system 200, and/or the MISO system 300. At step 808, the cost analysis function analysis produces and passes a filtered error directly to the fuel controller 202. The electric controller 204, at step 810, injects electric power into the system 100, the SISO system 200, and/or the MISO system 300.

The cost function analysis, at step 812, determines the desired output rate is achieved. For example, in response to a measured target engine parameter meeting a desired target engine parameter, the main controller 102 may reduce the power supplied by the LPEM 116 and/or HPEM 118 to a base power (e.g., the base power may correspond to a power value generally required to operate the aircraft and/or the engine 210).

The cost function analysis, at step 814, removes electric power from the system while maintaining sufficient fuel flow rate. For example, upon a determination that the measured target engine parameter has met the desired target engine parameter, the main controller 102 may stop power supplied by the LPEM 116 and/or HPEM 118. In some embodiments, the cost function analysis may, at step 816, include the main controller 102 determining that the desired reference command has been achieved.

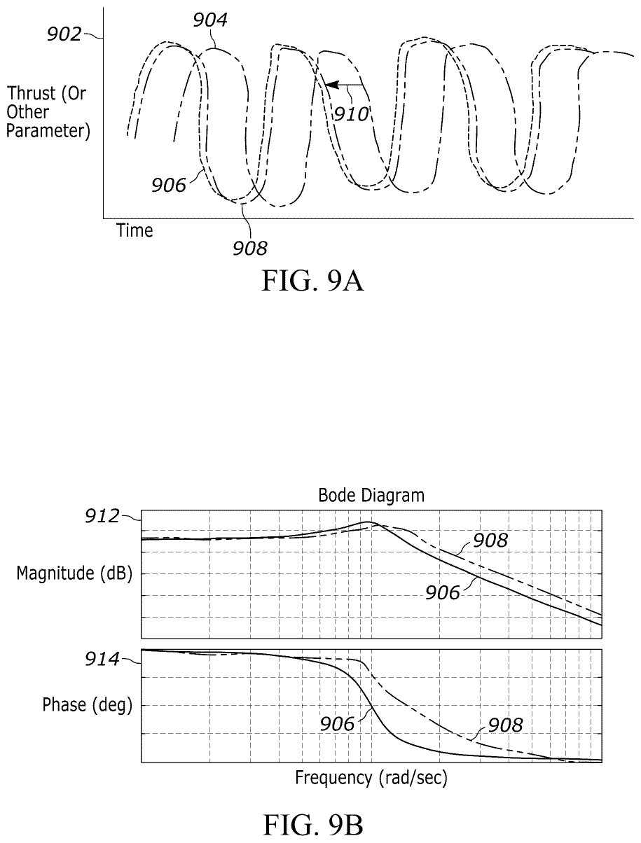

FIG. 9A illustrates the effect of using an electric machine in compensating for the phase loss condition in an engine in accordance with some embodiments. In FIG. 9A, a diagram 902 is shown depicting an example phase difference between a system (e.g., the system 100 of FIG. 1A and the SISO system 200 and the MISO system 300) that has one or more electric machines integrated with a main controller. For example, a response signal 906 may correspond to a demand command received by the main controller 102. As illustrated, the response signal 904 includes a delay 910 while the response signal 908 (e.g., a response signal that may be output by the system 100 of FIG. 1A and the SISO system 200 and the MISO system 300) is relatively close in phase with the response signal 906.

In an illustrative non-limiting example, the phase loss associated with delays or transport lags can be recovered using an input with a quicker response (e.g., additional electric power is applied as described herein). In such an example, the result is an increase in phase that allows for the original control loop to be tuned more aggressively such that an overall larger system bandwidth is achieved. By “increase in phase,” it is meant that the system response to a demand is closer to the time the demand is commanded.

FIG. 9B illustrates the effect of using electric machine in compensating for the phase loss condition in an engine in accordance with some embodiments. For example, in diagram 912, it can be seen that the peak of the response signal 908 occurs at a higher frequency than the response signal 906. In another example, in diagram 914, the phase of the response signal 908 is greater than the phase of the response signal 906 as the frequency increases.

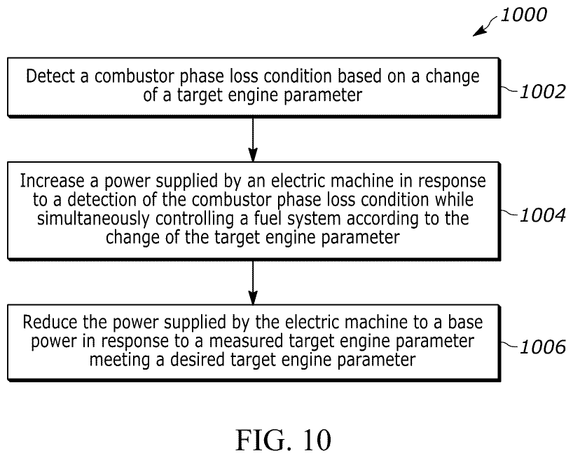

FIG. 10 shows a flow diagram of an example method 1000 in accordance with some embodiments. In some embodiments, the method 1000 may be implemented by the main controller 102, the fuel controller 202, the electric controller 204, the MISO controller 302 of the corresponding system 100 of FIG. 1A, SISO system 200 and/or MISO system 300 of FIGS. 2-4. In some embodiments, one or more steps of the method 1000 may be implemented by one or more elements or components shown in FIGS. 1-4.

The method 1000 includes, at step 1002, detecting, by a main controller coupled to an electric machine and a fuel system, a combustor phase loss condition based on a change of a target engine parameter.

The method 1000 includes, at step 1004, increasing, by the main controller, a power supplied by the electric machine in response to detection of the combustor phase loss condition while simultaneously controlling the fuel system according to the change of the target engine parameter. In some embodiments, the fuel system provides fuel to a combustor. In some embodiments, the electric machine supplies torque to an engine shaft.

In response to a measured target engine parameter meeting a desired target engine parameter, the method 1000 includes, at step 1006, reducing, by the main controller, the power supplied by the electric machine to a base power.

Further aspects of the disclosure are provided by the subject matter of the following clauses:

A gas turbine engine comprising: a fuel system to provide fuel to a combustor to generate high temperature exhaust gases to drive an engine shaft; an electric machine coupled to the engine shaft, the electric machine configured to supply torque to the engine shaft; and a main controller coupled to the electric machine and the fuel system, the main controller configured to: detect a combustor phase loss condition based on a sensed change of a target engine parameter; increase a power supplied by the electric machine in response to detection of the combustor phase loss condition while simultaneously controlling the fuel system according to the sensed change of the target engine parameter; and in response to a measured target engine parameter meeting a desired target engine parameter, reduce the power supplied by the electric machine to a base power.

The gas turbine engine of any preceding clause, wherein the main controller is configured to detect the combustor phase loss condition by determining a difference between a first cost factor and a second cost factor, wherein the first cost factor comprises a difference between the desired target engine parameter and the measured target engine parameter, and wherein the second cost factor comprises a net electric power demanded to the electric machine.

The gas turbine engine of any preceding clause, wherein the desired target engine parameter comprises at least one of a thrust of the engine shaft, a speed of the engine shaft, a pressure ratio of a high compressor and a low compressor of the gas turbine engine, the torque supplied to the engine shaft, or a power supplied to the gas turbine engine.

The gas turbine engine of any preceding clause, wherein in detecting the combustor phase loss condition, the main controller is configured to: execute a compute cost algorithm to determine the difference between the first cost factor and the second cost factor; and output a value to an electric controller of the electric machine, wherein the value determines whether the power supplied is increased or reduced.

The gas turbine engine of any preceding clause, further comprising a filter, the filter configured to: receive the value from the main controller; and output a filtered value to the electric controller.

The gas turbine engine of any preceding clause, wherein the sensed change in the target engine parameter corresponds to a difference between the desired target engine parameter and the measured target engine parameter.

The gas turbine engine of any preceding clause, wherein the desired target engine parameter is based on an input commanded by a user.

The gas turbine engine of any preceding clause, wherein the base power corresponds to a default power demanded by an aircraft to the gas turbine engine.

The gas turbine engine of any preceding clause, wherein the main controller detects the combustor phase loss condition by determining a difference between a first cost factor and a second cost factor, wherein the first cost factor comprises a difference between the desired target engine parameter and an estimated engine parameter, and wherein the second cost factor comprises a net electric power demanded to the electric machine.

The gas turbine engine of any preceding clause, wherein the main controller comprises an electric controller of the electric machine and a fuel controller of the fuel system.

A method for gas turbine engine, the method comprising: detecting, by a main controller coupled to an electric machine and a fuel system, a combustor phase loss condition based on a change of a target engine parameter; increasing, by the main controller, a power supplied by the electric machine in response to detection of the combustor phase loss condition while simultaneously controlling the fuel system according to the change of the target engine parameter, wherein the fuel system provides fuel to a combustor, and wherein the electric machine supplies torque to an engine shaft; and in response to a measured target engine parameter meeting a desired target engine parameter, reducing, by the main controller, the power supplied by the electric machine to a base power.

The method of any preceding clause, further comprising, in detecting the combustor phase loss condition, determining, by the main controller, a difference between a first cost factor and a second cost factor, wherein the first cost factor comprises a difference between the desired target engine parameter and the measured target engine parameter, and wherein the second cost factor comprises a net electric power demanded to the electric machine.

The method of any preceding clause, wherein the target engine parameter comprises at least one of a thrust of the engine shaft, a speed of the engine shaft, a pressure ratio of a high compressor and a low compressor of the gas turbine engine, the torque supplied to the engine shaft, or a power supplied to the gas turbine engine.

The method of any preceding clause, further comprising: in detecting the combustor phase loss condition, executing, by the main controller, a compute cost algorithm to determine the difference between the first cost factor and the second cost factor; and outputting, by the main controller, a value to an electric controller of the electric machine, wherein the value determines whether the power supplied is increased or reduced.

The method of any preceding clause, further comprising: receiving, by a filter, the value from the main controller; and outputting, by the filter, a filtered value to the electric controller.

The method of any preceding clause, wherein the change in the target engine parameter corresponds to a difference between the desired target engine parameter and the measured target engine parameter.

The method of any preceding clause, wherein the desired target engine parameter is based on an input commanded by a user.

The method of any preceding clause, wherein the base power corresponds to a default power demanded by an aircraft to the gas turbine engine.

The method of any preceding clause, further comprising, in detecting the combustor phase loss condition, determining, by the main controller, a difference between a first cost factor and a second cost factor, wherein the first cost factor comprises a difference between the desired target engine parameter and an estimated engine parameter, and wherein the second cost factor comprises a net electric power demanded to the electric machine.

The method of any preceding clause, wherein the main controller comprises an electric controller of the electric machine and a fuel controller of the fuel system.

Those skilled in the art will recognize that a wide variety of other modifications, alterations, and combinations can also be made with respect to the above described embodiments without departing from the scope of the disclosure, and that such modifications, alterations, and combinations are to be viewed as being within the ambit of the inventive concept.

1. A gas turbine engine comprising:
a fuel system to provide fuel to a combustor to generate high temperature exhaust gases to drive an engine shaft;
an electric machine coupled to the engine shaft, the electric machine configured to supply torque to the engine shaft; and
a main controller coupled to the electric machine and the fuel system, the main controller configured to:
detect a combustor phase loss condition based on a sensed change of a target engine parameter;
increase a power supplied by the electric machine in response to detection of the combustor phase loss condition while simultaneously controlling the fuel system according to the sensed change of the target engine parameter; and
in response to a measured target engine parameter meeting a desired target engine parameter, reduce the power supplied by the electric machine to a base power.

2. The gas turbine engine of claim 1, wherein the main controller is configured to detect the combustor phase loss condition by determining a difference between a first cost factor and a second cost factor, wherein the first cost factor comprises a difference between the desired target engine parameter and the measured target engine parameter, and wherein the second cost factor comprises a net electric power demanded to the electric machine.

3. The gas turbine engine of claim 2, wherein the desired target engine parameter comprises at least one of a thrust of the engine shaft, a speed of the engine shaft, a pressure ratio of a high compressor and a low compressor of the gas turbine engine, the torque supplied to the engine shaft, or a power supplied to the gas turbine engine.

4. The gas turbine engine of claim 2, wherein in detecting the combustor phase loss condition, the main controller is configured to:
execute a compute cost algorithm to determine the difference between the first cost factor and the second cost factor; and
output a value to an electric controller of the electric machine, wherein the value determines whether the power supplied is increased or reduced.

5. The gas turbine engine of claim 4, further comprising a filter, the filter configured to:
receive the value from the main controller; and
output a filtered value to the electric controller.

6. The gas turbine engine of claim 1, wherein the sensed change in the target engine parameter corresponds to a difference between the desired target engine parameter and the measured target engine parameter.

7. The gas turbine engine of claim 6, wherein the desired target engine parameter is based on an input commanded by a user.

8. The gas turbine engine of claim 1, wherein the base power corresponds to a default power demanded by an aircraft to the gas turbine engine.

9. The gas turbine engine of claim 1, wherein the main controller detects the combustor phase loss condition by determining a difference between a first cost factor and a second cost factor, wherein the first cost factor comprises a difference between the desired target engine parameter and an estimated engine parameter, and wherein the second cost factor comprises a net electric power demanded to the electric machine.

10. The gas turbine engine of claim 1, wherein the main controller comprises an electric controller of the electric machine and a fuel controller of the fuel system.

11. A method for gas turbine engine, the method comprising:
detecting, by a main controller coupled to an electric machine and a fuel system, a combustor phase loss condition based on a change of a target engine parameter;
increasing, by the main controller, a power supplied by the electric machine in response to detection of the combustor phase loss condition while simultaneously controlling the fuel system according to the change of the target engine parameter, wherein the fuel system provides fuel to a combustor, and wherein the electric machine supplies torque to an engine shaft; and
in response to a measured target engine parameter meeting a desired target engine parameter, reducing, by the main controller, the power supplied by the electric machine to a base power.

12. The method of claim 11, further comprising, in detecting the combustor phase loss condition, determining, by the main controller, a difference between a first cost factor and a second cost factor, wherein the first cost factor comprises a difference between the desired target engine parameter and the measured target engine parameter, and wherein the second cost factor comprises a net electric power demanded to the electric machine.

13. The method of claim 12, wherein the target engine parameter comprises at least one of a thrust of the engine shaft, a speed of the engine shaft, a pressure ratio of a high compressor and a low compressor of the gas turbine engine, the torque supplied to the engine shaft, or a power supplied to the gas turbine engine.

14. The method of claim 12, further comprising:
in detecting the combustor phase loss condition, executing, by the main controller, a compute cost algorithm to determine the difference between the first cost factor and the second cost factor; and
outputting, by the main controller, a value to an electric controller of the electric machine, wherein the value determines whether the power supplied is increased or reduced.

15. The method of claim 14, further comprising:
receiving, by a filter, the value from the main controller; and
outputting, by the filter, a filtered value to the electric controller.

16. The method of claim 11, wherein the change in the target engine parameter corresponds to a difference between the desired target engine parameter and the measured target engine parameter.

17. The method of claim 16, wherein the desired target engine parameter is based on an input commanded by a user.

18. The method of claim 11, wherein the base power corresponds to a default power demanded by an aircraft to the gas turbine engine.

19. The method of claim 11, further comprising, in detecting the combustor phase loss condition, determining, by the main controller, a difference between a first cost factor and a second cost factor, wherein the first cost factor comprises a difference between the desired target engine parameter and an estimated engine parameter, and wherein the second cost factor comprises a net electric power demanded to the electric machine.

20. The method of claim 11, wherein the main controller comprises an electric controller of the electric machine and a fuel controller of the fuel system.
